(19) United States
(12) Patent Application Publication
(10) Pub. No.: US 2017/0265456 A1
(43) Pub. Date: Sep. 21, 2017

(54) ORGAN PRESERVATION SOLUTION AND METHODS OF USE THEREOF IN THE INHIBITION OF ISCHEMIA-REPERFUSION INJURY

(71) Applicant: The Research Foundation for the State University of New York, Albany, NY (US)

(72) Inventors: Ming Zhang, Brooklyn, NY (US); Tak Lee, Brooklyn, NY (US)

(21) Appl. No.: 15/461,519

(22) Filed: Mar. 17, 2017

Related U.S. Application Data
(60) Provisional application No. 62/310,892, filed on Mar. 21, 2016.

(51) Int. Cl. A01N 1/02

(52) U.S. Cl. CPC A01N 1/0226

(57) ABSTRACT

Compositions and methods for preserving organs, maintaining organ viability and inhibiting ischemia-reperfusion injury and the like are disclosed.

### CROSS-REFERENCE TO RELATED APPLICATIONS

The present application claims the benefit of U.S. Provisional Patent Application No. 62/310,892, filed Mar. 21, 2016, the entire disclosure of which is incorporated by reference herein.

### FIELD OF THE INVENTION

This invention relates to the fields of molecular biology and biochemistry. More specifically, the invention provides compositions and methods for the maintenance of organ viability and preservation of organs from ischemia-reperfusion injury.

### BACKGROUND OF THE INVENTION

Numerous publications and patent documents, including both published applications and issued patents, are cited throughout the specification in order to describe the state of the art to which this invention pertains. Each of these citations is incorporated herein by reference as though set forth in full.

Ischemia/reperfusion (I/R) injury is a major complicating feature of many clinical disease entities. In general, I/R represents an acute inflammatory response after an ischemic event and subsequent restoration of blood flow [1]. I/R is responsible for much of the severity of myocardial infarction, cerebral ischemic events, intestinal ischemia, and many aspects of vascular surgery, trauma, and transplantation [1]. Intestinal I/R is a devastating syndrome. Approximately one-third of episodes are acute events and are responsible for most gastro-intestinal ischemia-related deaths (mortality rate of 70-90%); this attests to the lethal nature of the disease if it is not recognized and treated promptly [2].

During ischemia, hypoxic cells undergo specific changes in enzymatic activities, mitochondrial function, cytoskeletal structure, membrane transport, and antioxidant defenses. Intestinal I/R injury is a manifestation of the intracellular response to ischemia, i.e. formation of reactive oxygen species leading to cell membrane damage [3-5] and acute inflammation due to extracellular factors, i.e. activation of the complement system [6]. Recent studies in a murine intestinal model have identified natural IgM as a major initiator of complement activation in I/R, specifically, the mounting of an innate immune response to self-antigens which are exposed during ischemia [7-11].

Intestinal failure is inevitable in short bowel syndrome, a devastating clinical condition with 30% mortality in the 4 years following diagnosis [12, 13]. Annual medical costs range from about $50,000 to more than $200,000. Although intestinal transplantation is the therapy of choice, early postoperative mortality rates can be as high as 30%. A critical issue is the sensitivity of the donor intestine to ischemia which results in I/R injury. The current standard tissue preservation solution, Viaspan (University of Wisconsin buffer), is suboptimal for intestinal grafts, despite good results with other organs [14]. Clearly, improvements in organ preserving solutions for the maintenance of organ viability and inhibition of ischemia-reperfusion injury are needed.

### SUMMARY OF THE INVENTION

In accordance with the present invention, an organ perfusion solution for maintaining donor organ viability and inhibiting ischemia-reperfusion injury is provided. In one embodiment, the organ perfusion solution is composed of 0.0001-0.002 mg/mL heparin sodium salt, 0.015-0.3 mg/mL N-acetyl-L-cysteine, 7-140 mg/mL Trehalose, and 0.1-1% sodium chloride. In a preferred embodiment, the organ perfusion solution is composed of 0.001 mg/mL heparin sodium salt, 0.15 mg/mL N-acetyl-cysteine, 70 mg/mL Trehalose, and 0.9% sodium chloride.

Also provided is a method for preserving an organ comprising placing the organ in the organ perfusion solution to maintain viability of the organ and inhibit ischemia-reperfusion injury. In one embodiment, the organ perfusion solution has a temperature of between 0° and 10°. In a preferred embodiment, the solution has a temperature of 4°.

In certain embodiments, the organ placed in the organ perfusion solution can be an intestine, a kidney, a liver, a lung, skin, a pancreas or a heart. In a preferred embodiment, the organ is an intestine. The organs can be recovered from a heart-beating or non-heart-beating donor.

In another aspect, this disclosure features methods that include immersing the organ in the organ perfusion solution described above. The methods can include placing the organ in the solution, placing the organ in the solution under continuous pulsatile perfusion, or rinsing or flushing the organ.

### BRIEF DESCRIPTION OF THE DRAWINGS

FIG. 1. Quantification of normal intestinal villi following ZL solution, saline and UW solution preservation of mouse intestines (n=1 mice).

FIG. 2. Quantification of normal intestinal villi following ZL and UW solution preservation of mouse intestines (n=13 mice).

FIG. 3. Quantification of normal intestinal villi following ZL and UW solution preservation of human intestines (n=5 patients).

### DETAILED DESCRIPTION OF THE INVENTION

Based on previous studies on the mechanism of intestinal ischemia/reperfusion injury, we have developed an intestine preservation solution for the inhibition of ischemia-reperfusion injury. The intestine preservation solution (ZL solution) is comprised of combinations of a complement inhibitor/anti-coagulant, anti-oxidant, and cell membrane stabilizer. Specifically, the preservation solution comprises: heparin, N-acetyl-L-cysteine, trehalose, and sodium chloride. The composition of our solution is distinct from the current standard preservation solution, University of Wisconsin solution (UW solution; U.S. Pat. No. 4,798,824).

The following ranges of our solution composition have been tested:
1) Heparin sodium salt: 0.0001-0.002 mg/ml (optimal concentration: 0.001 mg/mL)
2) N-acetyl-L-cysteine: 0.015-0.3 mg/ml (optimal concentration: 0.15 mg/mL)
3) Trehalose: 7-140 mg/ml (optimal concentration: 70 mg/mL)
4) Sodium chloride: 0.1-1% (optimal concentration: 0.9%)

ZL solution was tested in procured mouse intestine under cold storage preservation conditions. Control groups included intestine preserved with saline or UW solution. Histological analysis quantified the number of normal intestinal villi. The saline preserved intestines lacked normal villi after cold preservation. The UW preserved intestines showed reduced protection compared to the intestines treated with ZL solution which exhibited a statistically significant increase in the number of preserved normal villi.

Additional studies compared the preservation effect of ZL solution on human intestine. Intestine obtained from patients who had undergone bowel resection surgery was preserved in cold storage with ZL or UW solution. ZL solution preservation resulted in a 3-fold increase in preserved normal intestinal villi compared to intestines stored in the UW solution.

### DEFINITIONS

For purposes of the present invention, “a” or “an” entity refers to one or more of that entity. As such, the terms “a” or “an,” “one or more” and “at least one” can be used interchangeably herein. It is also noted that the terms “comprising,” “including,” and “having” can be used interchangeably. Furthermore, a compound “selected from the group consisting of” refers to one or more of the compounds in the list that follows, including mixtures (i.e. combinations) of two or more of the compounds.

In this disclosure, “comprises,” “comprising,” “containing” and “having” and the like can have the meaning ascribed to them in U.S. Patent law and can mean “ includes,” “including,” and the like; “consisting essentially of” or “consists essentially” likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments.

“Effective amount” is meant the amount of a composition of the invention required to inhibit ischemia-reperfusion injury relative to an untreated organ.

According to the present invention, an isolated, or biologically pure molecule is a compound that has been removed from its natural milieu. As such, “isolated” and “biologically pure” do not necessarily reflect the extent to which the compound has been purified. An isolated compound of the present invention can be obtained from its natural source, can be produced using laboratory synthetic techniques or can be produced by any such chemical synthetic route.

Unless specifically stated or obvious from context, as used herein, the term “or” is understood to be inclusive. Unless specifically stated or obvious from context, as used herein, the terms “a”, “an”, and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

“Sample” or “patient sample” or “biological sample” generally refers to a sample which may be tested for a particular molecule. Samples may include but are not limited to cells, body fluids, including blood, serum, plasma, bone aspirate, urine, saliva, tears, CSF, pleural fluid, tissue, organs and the like.

The terms “agent” and “compound” are used interchangeably herein and denote a chemical compound, a mixture of chemical compounds, a biological macromolecule, or an extract made from biological materials such as bacteria, plants, fungi, or animal (particularly mammalian) cells or tissues.

The term “modulate” as used herein refers to increasing or decreasing. For example, the term modulate refers to the ability of a compound or agent to decrease ischemia-reperfusion injury.

A “transplant” or “donor organ” can be any organ of the body, such as intestine, a kidney, a liver, a lung, skin, a pancreas, or a heart.

The term “preserving” denotes placing an organ in a solution, rinsing or flushing an organ with a solution, or placing the organ under continuous or pulsatile perfusion with a solution.

The following materials and methods are provided to facilitate the practice of the present invention.

### EXAMPLE I

### Development of a Novel Preservation Solution Against Intestinal Ischemia/Reperfusion Injury

Intestinal failure is a potentially fatal syndrome associated with a mortality rate as high as 30%. Intestinal transplantation remains the therapy of choice for critically ill patients but early postoperative mortality rates can exceed 30%. One major barrier to intestinal transplantation is the extreme sensitivity of donor intestine to ischemia, resulting in ischemia-reperfusion (IR) injury and poor clinical outcome. We developed a novel preservation solution with an optimal combination of complement inhibitors, anti-oxidants, trehalose, pH and ions that inhibited intestinal I/R injury and preserved intestinal villi. The preservation buffer (ZL solution) consisted of heparin sodium salt (0.001 mg/mL), N-acetyl-L-cysteine (0.15 mg/mL), Trehalose (70 mg/mL), and sodium chloride (0.9%) (normal saline).

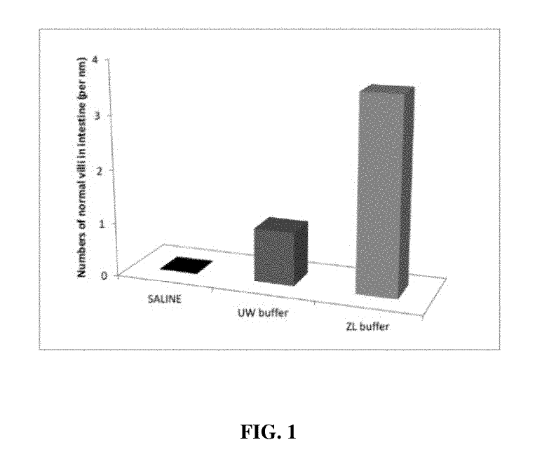

ZL solution was tested in procured mouse intestine stored at 4° C. for 24 hours (n=1). Control groups included intestines stored in saline or UW solution. H & E staining and microscopic analysis was performed to evaluate the number of normal intestinal villi. The numbers of normal villi were quantified microscopically in the preserved tissue slices and normalized with the lengths of tissues analyzed (FIG. 1). The saline preserved group lacked villi following 24 hours cold preservation. While the intestines preserved in UW solution exhibited some protection, the intestines stored in ZL solution showed a 3-fold greater number of normal villi.

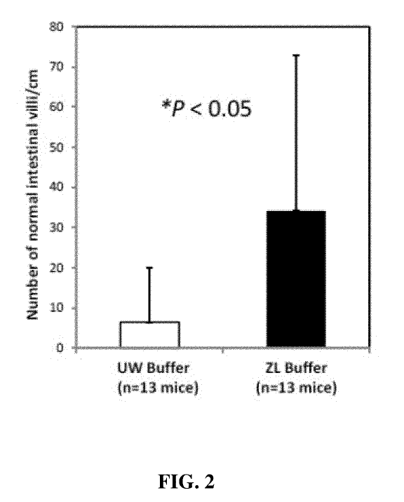

We subsequently performed a larger study. Mouse intestine was procured in ZL or UW solution (n=13 mice) and preserved for 24 hours in cold storage conditions (4° C.). Intestinal histology was evaluated using H & E staining and microscopic analysis. The numbers of normal intestinal villi were counted in the preserved tissue slices and normalized with the lengths of tissues analyzed. The results showed that ZL solution preservation increased the number of normal intestinal villi 5-fold compared to the intestine stored in the UW solution (FIG. 2).

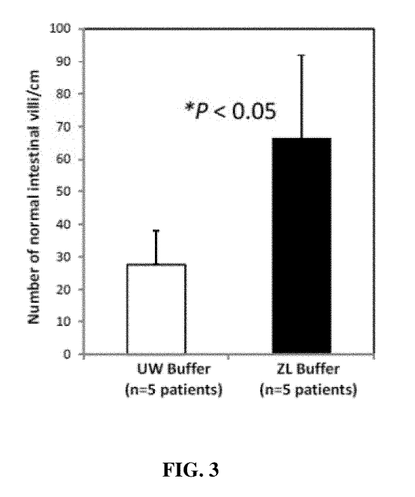

To evaluate the preservation effect on human intestine, human intestinal tissues were obtained from 5 patients who had undergone bowel resection surgery. Tissue was stored for 24 hours at 4° C. in ZL or UW solution. The intestines preserved in ZL solution showed a 2-fold greater number of normal intestinal villi compared to the intestines stored in UW solution (FIG. 3).

These results indicate that ZL solution provides superior preservation for procured intestine from mice and humans. An additional advantage of ZL solution over UW solution is the reduced number of chemical components (4 versus 13, respectively), which will translate into lower cost and better applications in clinical situations. The same is true with respect to other organ preservation solutions of the prior art.

### REFERENCES

1. Cotran, R. S. (1999) in Robbins Pathologic Basis of Disease (Saunders, St. Louis), pp. 7-12.
2. Lawrence, J. B. (2003) in Current Diagnosis & Treatment in Gastroenterology, ed. Friedman, S. L. (McGraw-Hill, New York), Section 1.9.
3. Koike, K., Moore, E. E., Moore, F. A., Franciose, R. J., Fontes, B. & Kim, F. J. (1995) J. Trauma 39, 23-27; discussion, 27-28.
4. Simpson, R., Alon, R., Kobzik, L., Valeri, C. R., Shepro, D. & Hechtman, H. B. (1993) Ann. Surg. 218, 444-453; discussion, 453-454.
5. Szabo, A., Boros, M., Kaszaki, J. & Nagy, S. (1997) Shock 8, 284-291.
6. Weisman, H. F., Bartow, T., Leppo, M. K., Marsh, H. C., Jr., Carson, G. R., Concino, M. F. Boyle, M. P., Roux, K. H., Weisfeldt, M. L. & Fearon, D. T. (1990) Science 249, 146-151.
7. Hill, J., Lindsay, T. F., Ortiz, F., Yeh, C. G., Hechtman, H. B. & Moore, F. D., Jr. (1992) J. Immunol. 149, 1723-1728.
8. Weiser, M. R., Williams, J. P., Moore, F. D., Kobzik, L., Ma, M., Hechtman, H. B. & Carroll, M. C. (1996) J. Exp. Med. 183, 2343-2348.
9. Williams, J. P., Pechet, T. T., Weiser, M. R., Reid, R., Kobzik, L., Moore, F. D., Carroll, M. C. & Hechtman, H. B. (1999) J. Appl. Physiol. 86, 938-942.
10. Fleming, S. D., Shea-Donohue, T., Guthridge, J. M., Kulik, L., Waldschmidt, T. J., Gipson, M. G., Tsokos, G. C. & Holers, V. M. (2002) J. Immunol. 169, 2126-2133.
11. Reid, R. R., Woodcock, S., Shimabukuro-Vornhagen, A., Austen, W. G., Jr., Kobzik, L., Zhang, M., Hechtman, H. B., Moore, F. D., Jr., & Carroll, M. C. (2002) J. Immunol. 169, 5433-5440.
12. Ladefoged K, Hessov I, Jarnum S. Scandinavian journal of gastroenterology. Supplement. 1996; 216:122-131
13. Howard L, Ament M, Fleming C R, Shike M, Steiger E. Gastroenterology. 1995; 109:355-365
14. Roskott A M, Nieuwenhuijs V B, Dijkstra G, Koudstaal L G, Leuvenink H G, Ploeg R J. Transplant international: official journal of the European Society for Organ Transplantation. 2011; 24:107-131

Furthermore, the transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinary associated with the specified material(s). The term “consisting essentially of” limits the scope of a claim to the specified elements, steps or material(s) and those that do not materially affect the basic and novel characteristic(s) of the claimed invention. Thus, the organ preservation solution of the present invention may suitably comprise, consist essentially of or consist of the above-described heparin sodium salt, N-acetyl-L-cysteine, Trehalose and sodium chloride components.

While certain of the preferred embodiments of the present invention have been described and specifically exemplified above, it is not intended that the invention be limited to such embodiments. Various modifications may be made thereto without departing from the scope of the present invention, as set forth in the following claims.

What is claimed is:

1. An organ perfusion solution for maintaining donor organ viability and inhibiting ischemia-reperfusion injury comprised of:
a) 0.0001-0.002 mg/mL Heparin sodium salt
b) 0.015-0.3 mg/mL N-acetyl-L-cysteine
c) 7-140 mg/mL Trehalose
d) 0.1-1% Sodium chloride.

2. The solution of claim 1, wherein the concentration of heparin sodium salt is 0.001 mg/mL.

3. The solution of claim 1, wherein the concentration of N-acetyl-cysteine is 0.15 mg/mL.

4. The solution of claim 1, wherein the concentration of Trehalose is 70 mg/mL.

5. The solution of claim 1, wherein the concentration of sodium chloride is 0.9%.

6. The solution of claim 1, wherein the concentration of heparin sodium salt is 0.001 mg/mL, N-acetyl-cysteine is 0.15 mg/mL, Trehalose is 70 mg/mL, and sodium chloride is 0.9%.

7. A method for preserving an organ comprising placing the organ in a solution according to claim 1 to maintain viability of the organ and inhibit ischemia-reperfusion injury.

8. The method according to claim 7, wherein the solution has a temperature of between 0° and 10° C.

9. The method according to claim 7, wherein the solution has a temperature of 4° C.

10. The method according to claim 7, further comprising rinsing or flushing the organ with the solution.

11. The method according to claim 7, further comprising placing the organ under continuous or pulsatile perfusion with the solution.

12. The method according to claim 7, wherein the organ is an intestine, a kidney, a liver, a lung, skin, a pancreas, or a heart transplant.

13. The method according to claim 12, wherein the organ is an intestine.

14. The method according to claim 12, wherein the organ is obtained from a heart-beating donor.

15. The method according to claim 12, wherein the organ is obtained from a non-heart-beating donor.

16. The method according to claim 12, wherein the organ is mammalian in origin.

17. The method according to claim 12, wherein the organ is human in origin.
